(19) United States
(12) Patent Application Publication
(10) Pub. No.: US 2008/0139443 A1
(43) Pub. Date: Jun. 12, 2008

(54) Acidic Hard Surface Cleaner with Alkoxylated Quaternary Compound

(75) Inventors: Brian T. Buzinski, Chicago, IL (US); Daniel S. Bertholf, Glenview, IL (US); John A. Schroeder, Racine, WI (US)

Correspondence Address: Jennifer E Lacroix;McANDREWS HELD & MALLOY LTD, 34th Floor, 500 West Madison Street, Chicago, IL, 60661, US

(73) Assignee: STEPAN COMPANY, Northfield, IL (US)

(21) Appl. No.: 11/578,764

(22) PCT Filed: Apr. 21, 2004
(86) PCT No.: PCT/US04/12395

§ 371 Date: Sep. 4, 2007

(51) Int. Cl. C11D 3/20

(52) U.S. Cl. 510/362

(57) ABSTRACT

A composition for cleaning hard surfaces, specifically, an acidic hard surface cleaner, includes a nonionic surfactant, a non-germicidal alkoxylated quaternary compound, an organic solvent, an acid, water, and optionally hydrogen peroxide, which provides excellent soap scum and/or greasy soil removal while exhibiting low filming and streaking.

### FIELD OF THE INVENTION

The invention relates to a composition for cleaning hard surfaces, more specifically, an acidic hard surface cleaner containing an alkoxylated quaternary compound, which provides excellent soap scum removal while maintaining low filming and streaking.

### BACKGROUND OF THE INVENTION

The development of household cleaners has long been driven by a particular challenge, namely, providing a cleaner with excellent cleaning ability while avoiding streaking or smearing after application to a surface. At the same time, it is also desirable that such cleaner be effective as a disinfectant. Therefore, it is desirable to have a cleaning product which may be effective as a soap scum remover and/or all-purpose cleaner, kitchen cleaner/degreaser, or bathroom cleaner, which does not leave residual chemical on the surface being cleaned and thereby cause filming or streaking.

It is well known that a household cleaner is typically aqueous and comprises an organic solvent to solubilize various soils, one or more surfactants (i.e., wetting agents or detersives), and a builder, which serves to chelate ions present in water and enhance the cleaning action of the solvent and/or surfactants. Household cleaners usually differ in composition, however, depending upon the type of soil they are meant to remove.

For example, soil removers for greasy materials (i.e., food soils, motor oils, etc.) typically employ a pH which renders the composition basic in nature, i.e., a pH greater than 7.0. See, e.g., WO 03/031549 (“3M Innovative Properties Company”); U.S. Pat. No. 6,605,584 (“Fong et al.”); U.S. Pat. No. 6,214,784 (“Robbins et al.”). Limescale, or soap-scum removers, on the other hand, typically employ a pH which renders the composition acidic in nature. See WO 00/63337 (“Reckitt Benckiser, Inc.”).

Additionally, germicidal quaternary ammonium compounds, high levels of certain alcohols, or oxidizing agents are typically used for disinfective purposes in household cleaning products. The desirability of these compounds, however, also depends on the intended use for the cleaning product. For example, oxidizing agents such as hydrogen peroxide are generally incompatible with an alkaline composition. Further, high levels of alcohols may be undesirable, as they may cause eye and skin irritation, unpleasant odor, and potential surface damaging effects.

Moreover, hard surface cleaners that employ a germicidal quaternary ammonium salt for cleaning/disinfecting purposes generally result in filming or streaking. For example, U.S. Pat. No. 6,605,584 to Fong, et al., describes how it is considered an orthodoxy in surfactant chemistry that quaternary ammonium compounds may deposit a large amount of residue on tested surfaces. Fong et al., however, discloses that the use of ethoxylated quaternary ammonium compounds in a hard surface cleaner may result in lower streaking/filming. Fong et al., however, is directed to an alkaline cleaner for greasy soils.

U.S. Pat. No. 6,358,900 (“Wigley et al.”) also discloses the use of an ethoxylated quaternary ammonium compound in a glass cleaner. Wigley, however, does not disclose an acidic pH of the composition, disinfection, or soap-scum removal.

Other examples of conventional hard surface cleaners include those disclosed in WO 03/031549 (“3M Innovative Properties”), which is an alkaline hard surface cleaner utilizing a halogen-based germicidal quaternary ammonium compound as a grease remover. WO 00/63337 (“Reckitt Benckiser, Inc.”) discloses an acidic hard surface cleaner, but without the use of an organic solvent such as glycol ether or an alkoxylated quaternary ammonium compound. U.S. Pat. No. 5,750,482 (“Cummings”), is said to disclose a non-streaking glass cleaning composition comprising an ethylene glycol monohexyl ether, a surfactant, an organic co-solvent, a builder, and water, with a pH range from about 3.5 to about 11.5, as a glass cleaning composition. Cummings, however, is not said to contemplate a non-filming cationic surfactant or suitability for effective soap scum or grease removal on surfaces other than glass.

There is therefore presently a need for a low-streaking, low-filming acidic hard surface cleaner capable of improved effective soap scum or grease removal, and/or effective disinfection, and optional incorporation of oxidizing or disinfecting agents.

### BRIEF SUMMARY OF THE INVENTION

The presently disclosed technology embodying a hard surface cleaning composition and method of use provides one or more of the following advantageous features:
(1) excellent soap scum removal;
(2) low streaking and/or filming on hard surfaces such as glass, metal, ceramic, or marble;
(3) disinfection; and
(4) excellent greasy soil removal.

Other objects of the presently disclosed technology will become apparent to those skilled in the art who have the benefit of this specification and the prior art.

In one embodiment, there is provided a hard surface cleaning composition comprising a nonionic surfactant, an alkoxylated cationic surfactant, a hydroxy-functional organic solvent, a monoprotic or polyprotic organic acid, and water, wherein the cleaning composition has a pH of less than 7.0. Preferably, the alkoxylated cationic surfactant is an ethoxylated or propoxylated non-germicidal quaternary ammonium compound. The hard surface cleaning composition is preferably suitable for use as a soap scum remover and/or a grease remover, and exhibits low streaking and/or filming on a hard surface. Although not limited to any one theory, it is believed that the acidic composition may provide effective disinfection as well as limescale deposit removal, without the need for an antimicrobial quaternary ammonium compound. It is believed that the alkoxylated cationic surfactant acts together with the acid and organic solvent to provide efficient soil removal which may result in synergistic performance.

In another embodiment of the present described technology, there is described a hard surface cleaning composition comprising hydrogen peroxide as an oxygen donator. It is believed that the addition of hydrogen peroxide is suitable because of its compatibility with the surfactants used and with the acidic system. It is further believed that the hydrogen peroxide aids in excellent greasy-soil removal in combination with the cationic surfactant and acid, without detracting from the effectiveness of the composition in removing soap scum. Additionally, further embodiments of the present technology may utilize additional germicidal quaternary ammonium compounds as disinfectants to enhance antimicrobial properties.

Yet other embodiments of the present technology include methods of cleaning hard surfaces comprising contacting a hard surface, such as, but not limited to glass, metal, marble, or ceramic, with the above-described hard surface cleaners.

While the presently described technology will be described in connection with one or more preferred embodiments, it will be understood by those skilled in the art that the presently described technology is not limited to those embodiments. On the contrary, the presently described technology includes all alternatives, modifications, and equivalents as may be included within the spirit and scope of the appended claims.

### DETAILED DESCRIPTION OF THE INVENTION

The invention provides a superior cleaning composition for excellent removal of soap scum and other bathroom or kitchen soils from a hard surface, while exhibiting low levels of streaking or filming. The cleaning composition described in the various embodiments is configured to clean hard surfaces by applying a sufficient amount of the cleaner, typically by pump or trigger sprayer onto the surface to be cleaned or onto a soft cloth, mop or sponge. Then, the cleaner is intended to be wiped from the surface, thus removing the soil and the cleaner, with or without rinsing with water. Typical surfaces include, but are not limited to shower stalls, glass mirrors and doors, toilets, countertops, tile floors and/or walls, kitchen countertops, stove-tops, and/or refrigerators. One or more embodiments of the present invention are effective both as a soap scum remover and as a greasy soil remover. The cleaning composition is an acidic aqueous liquid. Preferably, the cleaning composition has a pH of less than 7.0. More preferably, the cleaning composition has a pH of less than about 5.0, and most preferably less than about 4.0. The cleaning composition itself preferably comprises:

(a) a nonionic surfactant;

(b) an alkoxylated cationic surfactant;

(c) a hydroxy-functional organic solvent;

(d) a water soluble organic acid;

(e) water; and

(f) optionally, hydrogen peroxide and/or at least one germicidal quaternary ammonium compound.

Additionally, other additives such as, but not limited to, buffers, fragrances, dyes, thickeners, and foam stabilizers may be added as desired. It will be noted further, from the description and examples below, that combinations of ingredients may provide a synergistic effect, providing better soil removal when used in combination.

Yet other embodiments of the present technology include methods of cleaning hard surfaces comprising contacting a hard surface with the above-described hard surface cleaners.

### Nonionic Surfactant

The present invention uses a nonionic surfactant as a wetting agent, hydrotrope, and/or coupler. The nonionic surfactant is preferably a short chain compound. The term “nonionic surfactant,” as used herein, means both surfactants with no charge and “semi-polar nonionics” (also known as an amphoteric surfactants). Preferably, the nonionic surfactant is selected from alkoxylated branched or linear alcohols, polyhydritic alcohols, alkoxylated phenol ethers, and semi-polar nonionics such as amine oxides and betaines. Alkoxylated linear alcohols such as ethoxylated alcohols, propoxylated alcohols, butoxylated alcohols, and mixtures thereof are preferably utilized in the present technology. It is most preferred to use a C₆₋₁₁ short chain alcohol with 6-8 moles of ethylene oxide per mole of alcohol. Suitable alkoxylated phenol ethers include, but are not limited to oxtyl- and nonylphenol ethers, with preferably 1-10 moles of alkylene oxide per mole of phenol. Suitable amine oxides, include, but are not limited to cocoamidopropylamine oxide, cetamine oxide, lauramine oxide, laurylamine oxide, myristylamine oxide, steramine oxide, or combinations thereof. Suitable betaines include, but are not limited to alkyl betaines, sulfobetaines, cocobetaines, and amido propyl betaines, particularly including, but not limited to lauryl betaines, cocoamidopropyl betaines, lauramidopropyl betaines, and combinations thereof.

Ethoxylated alcohols are well known and may be formed from the condensation of an aliphatic alcohol, or mixtures thereof, with sufficient ethylene oxide to produce a compound having a polyoxyethylene. Preferably, the number of ethylene oxide units is sufficient to allow solubility in an aqueous solution. At least one ethoxylated alcohol useful in the present invention is the condensation product of linear or branched C₉-C₁₃ aliphatic alcohols with sufficient ethylene oxide to provide an average of at least 6-8 moles of ethylene oxide per molecule.

Among available commercial products, STEPOSOL® DG, sold by Stepan Company, Northfield, Ill., is a preferred blend of nonionic and cationic surfactants useful in the present technology. STEPANSOL® DG is a blend of ethoxylated alcohol and alkoxylated quaternary ammonium compounds. Other suitable nonionic surfactants sold by Stepan Company include, for example, the BIO-SOFT® N91 series surfactants, the BIO-SOFT® NI series, the BIO-SOFT® N25 series, the BIO-SOFT® N23 series, AMMONYX® LO, and AMMONYX® CDO Special. Yet other suitable nonionic surfactants include those disclosed in U.S. Pat. No. 6,605,584 (“Fong et al.”), incorporated by reference herein.

The nonionic surfactant is present in any effective amount. Generally, the amount of nonionic surfactant that may be utilized to practice the present technology is preferably between about 0.10% to about 12.0% by weight of the total hard surface cleaning composition, and more preferably, the amount of nonionic surfactant is between about 0.1% to about 10.0% by weight. Most preferably, the amount of nonionic surfactant is between about 1.0% to about 5.0% by weight.

### Alkoxylated Cationic Surfactant

The present technology uses an alkoxylated cationic surfactant, preferably an alkoxylated quaternary ammonium compound, in combination with the organic solvent and acid, to facilitate enhanced soil removal. Specifically; non-germicidal alkoxylated quaternary ammonium compounds typically exhibit enhanced soil removal performance without exhibiting the usual streaking and filming of germicidal quaternary ammonium compounds (such as dialkyl dimethyl ammonium chloride or didecyl dimethyl ammonium chloride).

The preferred alkoxylated cationic surfactant is an ethoxylated quaternary ammonium surfactant, such as that used in the STEPOSOL® DG blend, from Stepan Company. Ethoxylated quaternary ammonium compounds are also available as the Berol series from Akzo Nobel. The preferred ethoxylated quaternary ammonium surfactant has the general structure:

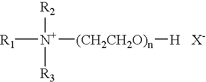

wherein:

R₁ is C₇-C₂₀, preferably C₉₋₁₁ and can be optionally alkoxylated;

each R₂ and R₃ is independently either hydrogen or C₁₋₆ alkyl, but preferably, at least one R₂ or R₃ is C₁₋₆ alkyl;

n is from 1 to 20, more preferably 3-9, most preferably 4-6; and

X⁻ is an anion, preferably non-halogen, such as methyl sulfate

Preferably, the alkoxylated cationic surfactant does not include halogen. Although not wanting to be bound by any one theory, it is believed that the non-halogen containing quaternary compounds are less corrosive.

The preferred amount of the alkoxylated cationic surfactant is from about 0.1 to about 10% by weight based on the total hard surface cleaning composition. More preferably, the amount of alkoxylated cationic surfactant is between about 0.1 to about 5% by weight based on the total hard surface cleaning composition. Most preferably, the amount of cationic surfactant is between about 1% to about 5% by weight.

### Solvent

The solvent is preferably a hydroxy-functional organic solvent. By hydroxy-functional, it is meant that the organic solvent contains at least one —OH functional group. The solvent is preferably a water soluble or dispersible organic solvent such as a glycol ether, glycol methyl ether acetate, isopropanol, ethanol, or mixture thereof. More preferably, the solvent is an alkylene glycol ether such as ethylene glycol monobutyl ether, diethylene glycol monobutyl ether, triethylene glycol monoethyl ether, diethylene glycol monoethyl ether, propylene glycol n-butyl ether, dipropylene glycol n-butyl ether, dipropylene glycol n-propyl ether, propylene glycol n-propyl ether, or mixtures thereof.

Most preferably, the solvent utilized in the present technology is Dowanol® EB, sold by Dow Chemicals, Midland, Mich., which is an ethylene glycol monobutyl ether. Other commercially available solvents useful in the present technology are Dow Chemical's Dowanol solvent series.

Preferably, the solvent comprises from between about 0.1% to about 10.0% by weight of the total hard surface cleaning composition. More preferably, the solvent comprises from between about 0.5% to about 8.0% by weight. Most preferably, it comprises about 1.0% to about 5.0% by weight.

### Acid

The present technology utilizes an organic acid as a builder, to amplify the detersive effect of the alkoxylated cationic surfactant, and to itself aid in soap scum removal and disinfection. It is well known in the art that an acidic composition is better suited for removal of limescale deposits than an alkaline composition. Furthermore, by using an acidic cleaning composition, additives such as oxygen donators may be used. By “oxygen donators” is meant a composition that releases a singlet oxygen in an aqueous system. Oxygen donators such as hydrogen peroxide, discussed below, may be used in the present technology. However, hydrogen peroxide is not typically compatible with the generally alkaline, conventional hard surface cleaners. The present hard surface cleaning composition, therefore, preferably has a pH of less than 7.0. More preferably, the cleaning composition has a pH of less than about 5.0, and most preferably, less than about 4.0

Certain acids are known to have antimicrobial properties and are recognized as antimicrobial agents by governmental agencies such as the United States Environmental Protection Agency. For example, U.S. Pat. No. 6,699,825 (“Rees et al.”) discloses the use of acids for antimicrobial purposes in a hard surface cleaner. Therefore, use of an acid may provide sufficient disinfection properties without the use of a germicidal quaternary ammonium compound, which generally increases streaking and/or filming.

Preferred acids for use in the present technology include, but are not limited to, water soluble monoprotic or polyprotic carboxylic acids. Preferred acids are citric, adipic, glycolic, malonic, succinic, lactic, maleic, glutaric, tartaric, gluconic, formic, oxalic, acetic, propionic, or butyric acids, or mixtures thereof. More preferred acids are citric, adipic, or glycolic acid. The most preferred acid is citric acid. Sulfonic acids, such as alkyl benzenesulfamic acid (where alkyl is C₆ to C₁₆), sulfamic acid, benzenesulfonic acid, methanesulfonic acid, and para-toluenesulfonic acid may also be used as water soluble organic acids by themselves or in combination with carboxylic acids. Peroxy acid variants of the above acids may also be used, they being derived from the reaction product of hydrogen peroxide and an acid. Also suitable in the present technology may be non-organic mineral acids with moderate pH, i.e. a pH of between about 2.0 to about 5.0, or more preferably, between about 2.5 to about 4.0. Examples of suitable non-organic mineral acids may be hydrochloric acid or sulfuric acid.

The acid may be present in any effective amount, but preferably, the acid comprises from between about 0.5% to about 10.0% by weight of the total hard surface cleaning composition. More preferably, the acid comprises from about 2.5% to about 10.0% by weight. Most preferably, the acid comprises about 3.0% to about 8.0% by weight.

Additionally, it may be desirable to include a buffer or pH-adjusting agent to stabilize the pH at a desired range. Useful pH buffers include inorganic and organic buffering agent such as alkali metal and alkaline earth metal hydroxides such as sodium hydroxide and potassium hydroxide.

### Water

The present hard surface cleaning composition is preferably aqueous. Water is added to the above-mentioned components of the cleaner, along with any of the additives discussed below, preferably as the remainder of the cleaner composition. Any suitable water source may be used. Distilled or deionized water is preferably used to avoid any impurities, especially impurities which may interfere with the acidic components of the cleaning composition or its soil removal properties. Preferably, water comprises from about 75% to about 98% by weight of the total cleaning composition. More preferably, water comprises about 82% to about 92% by weight of the total cleaning composition. Most preferably, water comprises about 85% to about 90% by weight of the total cleaning composition.

### Hydrogen Peroxide

It is believed that one advantage of the present acidic hard surface cleaning composition is its compatibility with hydrogen peroxide as an optional component, to aid in soil removal. Hydrogen peroxide based cleaners have become favored recently because they are odorless, non-corrosive at concentration levels typically employed for cleaning, safe to material substrates, their breakdown products (oxygen and water) are innocuous, and they can be made at low costs. Without being bound to any one theory, it is believed that hydrogen peroxide acts in combination with the organic solvent, alkoxylated cationic surfactant, and acid, to provide superior soil and stain removal.

Preferably, hydrogen peroxide may be added in pre-constituted form as an additive to the hard surface cleaning composition. Preferably, hydrogen peroxide comprises between about 0.1% to about 10.0% by weight of the total hard surface cleaning composition. More preferably, hydrogen peroxide comprises between about 1.0% to about 5.0% by weight of the total hard surface cleaning composition. Most preferably, it comprises about 1.0% to about 3.0% by weight of the total composition. Commercially, hydrogen peroxide may be obtained in 30%, 35%, 50%, 60%, and 70% aqueous technical grade commercial solution from Degussa Corporation, Peroxygen Chemicals Division, Parsippany, N.J., as the Hyprox™ series, or the high-grade Persynt™ series.

Alternatively, the source of hydrogen peroxide may be an oxygen-releasing compound present in an amount effective to produce hydrogen peroxide with the water of the cleaning composition. The oxygen-releasing compound can be percarbonate (e.g. sodium percarbonate), persilicate, persulphate, perborate (e.g. sodium perborate monohydrate and sodium perborate tetrahydrate), peroxyacids, dialkyl peroxides, diacyl peroxides, preformed percarboxylic acids, organic peroxides, inorganic peroxides, hydroperoxides, or mixtures thereof. Preferably, the oxygen-releasing compound is present in an amount effective to produce the above-described weight percents of hydrogen peroxide.

### Anti-Microbial Quaternary Ammonium

Optionally, the present hard surface cleaning composition may include further cationic surfactants, specifically, an anti-microbial quaternary ammonium compound. Anti-microbial quaternary ammonium compounds exhibit broad spectrum antimicrobial efficacy against both gram positive and gram negative microorganisms. Therefore, an additional amount of quaternary ammonium compound may be used to enhance the disinfectant ability of the present technology.

Preferred quaternary ammonium compounds are chloride based quaternary ammonium compounds including, but not limited to, didecyl dimethyl ammonium chloride, n-alkyl dimethyl benzyl ammonium chlorides, n-alkyl dimethyl ethylbenzyl ammonium chlorides, dialkyl dimethyl ammonium chloride, and mixtures thereof. Other suitable quaternary ammonium compounds are well known and are disclosed in U.S. Pat. No. 6,605,584 (“Fong et al.”), WO 00/63337 (“Reckitt Benckiser, Inc.”), and WO 03/031549 (“3M Innovative Properties Co.”), incorporated by reference herein.

Preferred commercial anti-microbial quaternary ammonium compounds include, but are not limited to the Stepan BTC® series, such as Stepan BTC 888®, which is a mixture of n-alkyl dimethyl ethylbenzyl ammonium chlorides and dialkyl dimethyl ammonium chloride. Preferably, the anti-microbial compound is present in an amount between about 0.01% to about 3%, more preferably, about 0.05% to about 0.20%, and most preferably, about 0.10% by weight of the total hard surface cleaning composition.

### Additives

The present hard surface cleaner may also comprise small amounts of additives to enhance soil or stain removal, storability, aesthetic quality, or other suitable attributes. For example, as discussed above, buffers may be used to stabilize the pH level of the cleaner. Additionally, other additives such as, but not limited to, fragrances, dyes, thickeners, and foam stabilizers may be added as desired. The amounts of these additives are preferably present in an amount less than 10% by weight of the total hard surface cleaning composition. More preferably, the additives are present in an amount less than 3% by weight of the total hard surface cleaning composition.

The following examples describe some of the preferred embodiments of the present technology without limiting the technology thereto. Other embodiments include, but are not limited to, those described in the above written description, including additional or alternative components, alternative concentrations, and additional or alternative properties and uses.

### EXAMPLES

### Table I: Example without Hydrogen Peroxide

Example 1 is a formulation of the present hard surface cleaner without hydrogen peroxide or additional disinfectant, and is as follows:

| Component | Example Weight % | Weight % Ranges |
|---|---|---|
| Steposol ® DG | 3.0% | 0.25-10.0% |
| Dowanol ® EB | 3.0% | 0.5-8.0% |
| Citric Acid | 5.0% | 2.5-10.0% |
| Water | 89.0% | Remainder |

pH: 2.0-5.0

### Table II: Example with Hydrogen Peroxide

A formulation of the present hard surface cleaner, Example 2, with hydrogen peroxide as an added soil and/or stain remover, is as follows:

| Component | Example Weight % | Weight % Ranges |
|---|---|---|
| Stepansol ® DG | 3.0% | 0.25-10.0% |
| Dowanol ® EB | 3.0% | 0.5-8.0% |
| Citric Acid | 5.0% | 2.5-10.0% |
| Hydrogen Peroxide, 50% | 4.0% | 0.1-10.0% |
| Water | 85.0% | Remainder |

pH: 2.0-5.0

The following Tables III, IV, and V illustrate examples 3-23 of the present hard surface cleaner. The components are indicated in weight percent of the total composition.

TABLE III
Examples 3-10

| | Examples | | | | | | | |
|---|---|---|---|---|---|---|---|---|
| | 3* | 4* | 5 | 6 | 7 | 8 | 9 | 10 |
| Steposol DG | 1.0 | 1.00 | 1.00 | 1.00 | 1.00 | 2.00 | 2.00 | 2.00 |
| BTC 888 | 0.07 | 0.07 | 0.07 | 0.07 | 0.07 | 0.07 | 0.07 | 0.07 |
| Dowanol EB | 3.00 | 3.00 | 3.00 | 3.0 | 3.0 | 3.0 | 3.0 | 3.0 |
| Citric Acid | 5.00 | 4.00 | 3.00 | 2.0 | 1.0 | 5.0 | 4.0 | 3.0 |
| Water | 90.93 | 91.93 | 92.93 | 93.93 | 94.93 | 89.93 | 90.93 | 91.93 |

TABLE IV
Examples 11-17

| | Examples | | | | | | |
|---|---|---|---|---|---|---|---|
| | 11* | 12* | 13* | 14 | 15 | 16 | 17 |
| Steposol DG | 2.0 | 2.0 | 3.0 | 3.0 | 3.0 | 3.0 | 3.0 |
| BTC 888 | 0.07 | 0.07 | 0.07 | 0.07 | 0.07 | 0.07 | 0.07 |
| Dowanol EB | 3.0 | 3.0 | 3.0 | 3.0 | 3.0 | 3.0 | 3.0 |
| Citric Acid | 2.0 | 1.0 | 5.0 | 4.0 | 3.0 | 2.0 | 1.0 |
| Water | 92.93 | 93.93 | 88.93 | 89.93 | 90.93 | 91.93 | 92.93 |

TABLE V
Examples 18-23

| | Examples | | | | | |
|---|---|---|---|---|---|---|
| | 18 | 19 | 20 | 21 | 22 | 23 |
| Steposol DG | 3.0 | 4.0 | 5.0 | 6.0 | 7.0 | 8.0 |
| BTC 888 | 0.07 | 0.07 | 0.07 | 0.07 | 0.07 | 0.07 |
| Dowanol EB | 3.0 | 3.0 | 3.0 | 3.0 | 3.0 | 3.0 |
| Citric Acid | 6.0 | 5.0 | 5.0 | 5.0 | 5.0 | 5.0 |
| Water | 87.93 | 87.93 | 86.93 | 85.93 | 84.93 | 83.93 |

*Performed the best at the levels shown in removing soap scum.

The formulations of Examples 3-23 were tested using the prescribed Stepan Method 250-B for soap scum removal. Soap scum is applied which is a complex layer of divalent fatty acids and other hard water salts. The soap scum is applied to a dark tile, and the tile is then heated to bake the soap scum on. The cleaning composition is then applied and soap scum removal is measured and visually observed.

During testing, the above formulations were compared to formulations without a solvent such as Dow Chemical's Dowanol Series. It was found that formulations without a solvent did not perform well in removing soap scum. The non-solvent formulations showed a slight softening of the soap scum; however, soil removed ranged from little to none. However, Examples 3, 4, 11, 12, and 13 of the presently described technology showed good soil removal. A phenomenon was observed which indicated that at 2% Steposol® DG, lower amounts of citric acid were more effective. At other levels of Steposol® DG, however, the best performing systems contained higher amounts of citric acid. A range of 1-10% Steposol® DG and a citric acid range of 1-5% gave the best performance. It is believed that such results are indicative of a synergistic effect between the surfactants and the citric acid.

In addition, the soap scum removal properties of the above formulations were compared to Tilex® Soap Scum Remover, a commercially available hard surface cleaner for consumer use. Tilex® Soap Scum Remover was compared to the formulations of the present technology using the above-described Stepan Method 250-B Method. Both formulations showed excellent soap scum removal in the test.

### Table VI: Hydrogen Peroxide Formulation

A number of tests were performed comparing the hydrogen peroxide formulation of Example 2 with several leading hard surface cleaners. The formulations were tested on oily soils using the Gardner Straight Line Test (Stepan Method 250-0 which is a Modified ASTM D4488-91). The formulations may also be tested using the traditional ASTM D4488-91 standard, which would produce similar results. The results are shown below:

| | Average Soil |
|---|---|
| | Removal, % |
| Fantastic ® Oxy Power | 48.43% |
| Formula 409 ® Oxi Magic | 65.70% |
| Formulation of Example 2 | 78.89% |

LSD₉₅ = 6.25

The invention has now been described in such full, clear, concise and exact terms as to enable any person skilled in the art to which it pertains, to practice the same. It is to be understood that the foregoing describes preferred embodiments and examples of the invention and that modifications may be made therein without departing from the spirit or scope of the invention as set forth in the claims.

What is claimed:

1. A hard surface cleaning composition comprising:
(a) a nonionic surfactant;
(b) an alkoxylated cationic surfactant;
(c) a hydroxy-functional organic solvent;
(d) a water soluble organic acid; and
(e) water
wherein, the hard surface cleaning composition has a pH of less than 7.0.

2. The hard surface cleaning composition of claim 1, wherein the pH is less than about 5.0.

3. The hard surface cleaning composition of claim 1, wherein the alkoxylated cationic surfactant comprises an ethoxylated or propoxylated quaternary ammonium compound present at about 0.1% to about 10% by weight of the hard surface cleaning composition.

4. The hard surface cleaning composition of claim 3, wherein the cleaning composition is configured to effectively remove limescale deposits from a hard surface.

5. The hard surface cleaning composition of claim 3, wherein the nonionic surfactant is selected from the group consisting of alkoxylated linear alcohols, amine oxides, polyhydritic alcohols, betaines, and mixtures thereof.

6. The hard surface cleaning composition of claim 5, wherein the nonionic surfactant is about 0.1% to about 10% by weight of the hard surface cleaning composition.

7. The hard surface cleaning composition of claim 3, wherein the water soluble organic acid is selected from the group consisting of citric, adipic, glycolic, malonic, succinic, lactic, maleic, glutaric, tartaric, gluconic, formic, oxalic, acetic, propionic, or butyric acids, and mixtures thereof.

8. The hard surface cleaning composition of claim 3, wherein the water soluble organic acid is present in an amount sufficient for effective disinfection.

9. The hard surface cleaning composition of claim 8, wherein the water soluble organic acid comprises about 1.0% to about 10% by weight of the hard surface cleaning composition.

10. The hard surface cleaning composition of claim 1, wherein the hydroxy-functional organic solvent is selected from the group consisting of glycol ethers, alkylene glycol ethers, glycol methyl ether acetates, isopropanol, ethanol, and mixtures thereof.

11. The hard surface cleaning composition of claim 1, wherein the composition is substantially free of halogen containing quaternary ammonium salts.

12. The hard surface cleaning composition of claim 1, further comprising an oxygen donating compound.

13. The hard surface cleaning composition of claim 12, wherein the oxygen donating compound is a peroxy compound.

14. The hard surface cleaning composition of claim 12, wherein the oxygen donating compound is hydrogen peroxide.

15. The hard surface cleaning composition of claim 14, wherein the hydrogen peroxide is present at about 1.0% to about 8.0% by weight.

16. The hard surface cleaning composition of claim 1, further comprising a germicidal cationic surfactant.

17. The hard surface cleaning composition of claim 16, wherein the germicidal cationic surfactant is a non-alkoxylated quaternary ammonium compound.

18. A hard surface cleaning composition comprising:
(a) about 0.1% to about 10% by weight of an ethoxylated or propoxylated nonionic surfactant;
(b) about 0.1% to about 10% by weight of an ethyoxylated quaternary ammonium compound;
(c) about 0.5% to about 10% by weight of a hydroxy-functional organic solvent;
(d) about 1.0% to about 10% by weight of a water soluble organic acid; and
(e) water
wherein, the hard surface cleaning composition has a pH of less than about 5.0.

19. The hard surface cleaning composition of claim 18, wherein the composition is substantially free of halogen containing quaternary ammonium salts.

20. The hard surface cleaning composition of claim 18, wherein the hydroxy-functional organic solvent is selected from the group consisting of glycol ethers, alkylene glycol ethers, glycol methyl ether acetates, isopropanol, ethanol, and mixtures thereof.

21. The hard surface cleaning composition of claim 18, wherein the water soluble organic acid is selected from the group consisting of citric, adipic, glycolic, malonic, succinic, lactic, maleic, glutaric, tartaric, gluconic, formic, oxalic, acetic, propionic, or butyric acids, and mixtures thereof.

22. The hard surface cleaning composition of claim 18, further comprising hydrogen peroxide present at about 1.0% to about 10.0% by weight.

23. The hard surface cleaning composition of claim 18, further comprising a germicidal quaternary ammonium compound.

24. A method of cleaning a hard surface comprising contacting said surface with the hard surface cleaner of claim 1.

25. A method of cleaning a hard surface comprising contacting said surface with the hard surface cleaner of claim 18.

26. The hard surface cleaning composition of claim 1, wherein the pH is less than about 4.0.

27. The hard surface cleaning composition of claim 17, wherein the pH is less than about 4.0.

28. A hard surface cleaning composition comprising:
(a) about 0.1% to about 10% by weight of an ethoxylated or propoxylated nonionic surfactant;
(b) about 0.1% to about 10% by weight of an ethyoxylated quaternary ammonium compound;
(c) about 0.5% to about 10% by weight of a hydroxy-functional organic solvent;
(d) about 2.5% to about 10% by weight of a non-organic acid with a pH between about 2.0 to about 5.0; and
(e) water
wherein, the hard surface cleaning composition has a pH of less than about 5.0.
